(19) United States
(12) Patent Application Publication
(10) Pub. No.: US 2014/0006658 A1
(43) Pub. Date: Jan. 2, 2014

(54) METHOD FOR OPERATING A HANDHELD COMPUTER BY USB INPUT DEVICES

(71) Applicant: Johnny Chen, Santa Ana, CA (US)

(72) Inventor: Johnny Chen, Santa Ana, CA (US)

(21) Appl. No.: 13/533,971

(22) Filed: Jun. 27, 2012

(51) Int. Cl. G06F 13/38

(52) U.S. Cl. 710/63

(57) ABSTRACT

A method allowing a user to use a USB input device to operate a handheld computer such as a smartphone or tablet is disclosed, The method includes the following steps of: a) connecting a handheld computer with an intermediary device through a wireless communication protocol and connecting a USB input device with the intermediary device through a USB cable; b) intercepting a data packet from the USB input device; c) repackaging the data packet; and d) transmitting the repackaged data packet to the handheld computer.

### BACKGROUND OF THE INVENTION

1. Technical Field

The present invention relates to handheld computers such as smartphones and tablet computers, particularly to connection of the handheld computers and input devices.

2. Related Art

Technically speaking, a smartphone or tablet computer is a handheld computer, as knows as a mobile computing device, even if it is unlike a conventional computer in appearance. A handheld computer typically has a display screen with touch input and weighing less than 2 pounds (0.91 kg). A handheld computer also has an operating system (OS), and can run various types of application software, known as apps. Most hand held devices can also be equipped with WI-FI, Bluetooth and GPS capabilities that can allow connections to the Internet and other Bluetooth capable devices such as an automobile or a microphone headset.

For the sake of minimization of size, a handheld computer is usually provided with a few function keys or even no tangible keys except a power key. However, sometimes users may need to input many letters, words or numbers, a simulated keyboard displayed on a touch screen is not convenient enough. Most of users still need physical keyboards for long-form typing. Although most handheld computers have a universal serial bus (USB), it is only for charge and connection with a desktop or laptop computer to synchronize or transfer data and cannot connect an input device such as a keyboard or mouse. As a result, a Bluetooth keyboard appears in the market to solve this problem

The Bluetooth keyboard allows users to type desktop-style as needed, but it is expensive and uneconomic for most non-business users because they have very little opportunity for using it. Also, even if a user has bought a Bluetooth keyboard, the user has to store it when not in use. This is inconvenient for users which occasionally use the Bluetooth keyboard. There indeed is a real requirement of connecting a general USB input device to a handheld computer for most users. Unfortunately, such a solution does not appear yet.

### SUMMARY OF THE INVENTION

An object of the invention is to provide a method which allows a user to operate a handheld computer by a Universal Serial Bus (USB) input device without using an expensive Bluetooth input device.

To accomplish the above object, the method of the invention includes the following steps of: a) connecting a handheld computer with an intermediary device through a wireless communication protocol and connecting a USB input device with the intermediary device through a USB cable; b) intercepting a data packet from the USB input device; c) repackaging the data packet; and d) transmitting the repackaged data packet to the handheld computer.

### BRIEF DESCRIPTION OF THE DRAWINGS

FIG. 1 is a schematic view showing the topology of the invention;

FIG. 2 is a flowchart of the invention; and

FIG. 3 is a block diagram of the intermediary device of the invention.

### DETAILED DESCRIPTION OF THE INVENTION

In the following detailed description of embodiment of the invention, reference is made to the accompanying drawings which form a part hereof, and in which is shown by way of illustration specific preferred embodiment in which the inventive subject matter may be practiced. This embodiment is described in sufficient detail to enable those skilled in the art to practice the inventive subject matter, and it is to be understood that other embodiments may be utilized and that logical, procedural, mechanical, and electrical changes may be made without departing from the spirit and scope of the present disclosure. The following detailed description is, therefore, not to be taken in a limiting sense, and the scope of the present inventive subject matter is defined only by the appended claims.

An embodiment of the present invention is directed to operating a handheld computer by a Universal Serial Bus (USB) input device. In the specification and claims of the present invention, the term “handheld computer” refers to a small, hand-held computing device with an operating system but does not include a laptop computer. Examples of such a handheld computer include, but not limited to, a smartphone, a tablet computer, a personal digital assistant (PDA) and an MP3 player. Also, all the handheld computers involved with the present invention are capable of wireless communication such as Bluetooth or Wi-Fi.

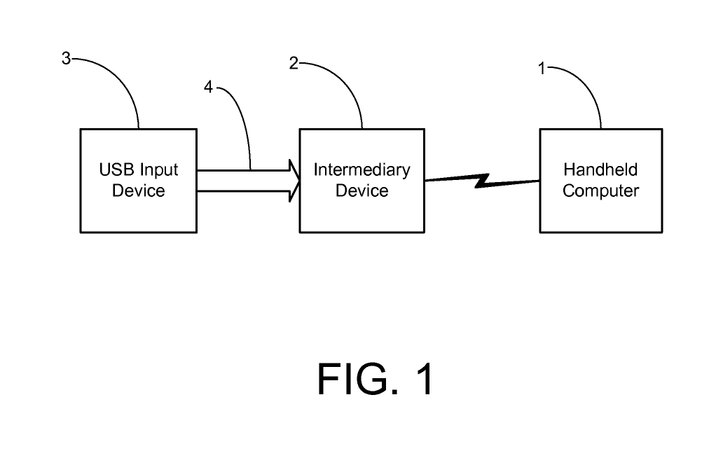

FIG. 1 shows topology of the invention. A handheld computer 1 is wirelessly connected to an intermediary device 2 and a universal serial bus (USB) input device 3 is connected to the intermediary device 2 through a USB cable 4. The intermediary device 2 may be a dock, hub, repeater or controller. The USB input device 3 may be a keyboard or mouse. The wireless connection between the handheld computer 1 and the intermediary device 2 may be Wi-Fi or Bluetooth, and of the two, the latter is especially preferred. The intermediary device 2 functions as an interface between the handheld computer 1 and the USB input device 3 so that a user can input characters or command to the handheld computer 1 by operating the USB input device 3. This can replace using an expensive Bluetooth input device.

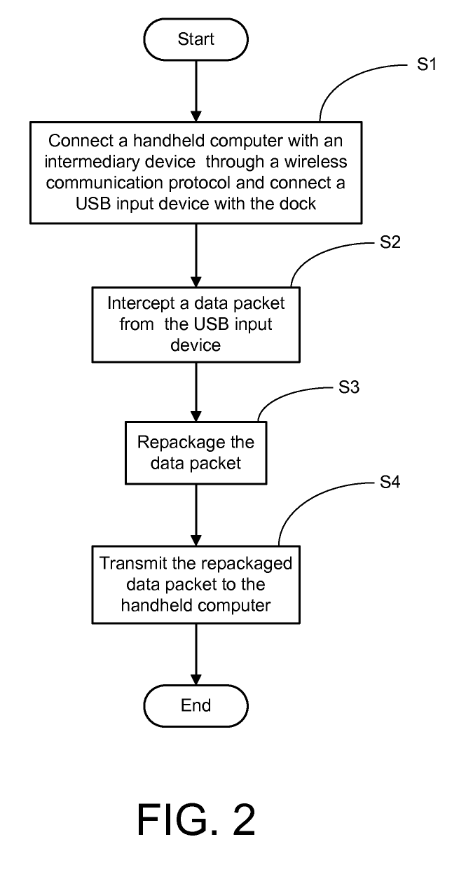

Please refer to FIG. 2, which shows a flowchart of the method of the invention. Initially, in step S1, the handheld computer 1 is operatively connected with the intermediary device 2 through a wireless communication protocol and the USB input device 3 is connected with the intermediary device 2 through the USB cable 4. As abovementioned, the wireless communication protocol may be Wi-Fi or Bluetooth. In this step, the handheld computer 1 and the USB input device 3 must be confirmed to operatively connect with the intermediary device 2.

In step S2, a data packet generated from the USB input 3 is intercepted when the USB input device 3 is being operated.

In step S3, the intercepted data packet is repackaged to be compatible with the handheld computer 1. In other words, the intercepted data packet is converted into a form accepted by the handheld computer 1.

In step S4, the repackaged data packet is transmitted to the handheld computer 1 to make the handheld computer 1 operated by the repackaged data packet.

By means of the method of the invention, a user may use a normal and cheap USB input device 3, such as a USB keyboard or mouse, to operate a handheld computer 1 without needing an expensive Bluetooth or Wi-Fi input device.

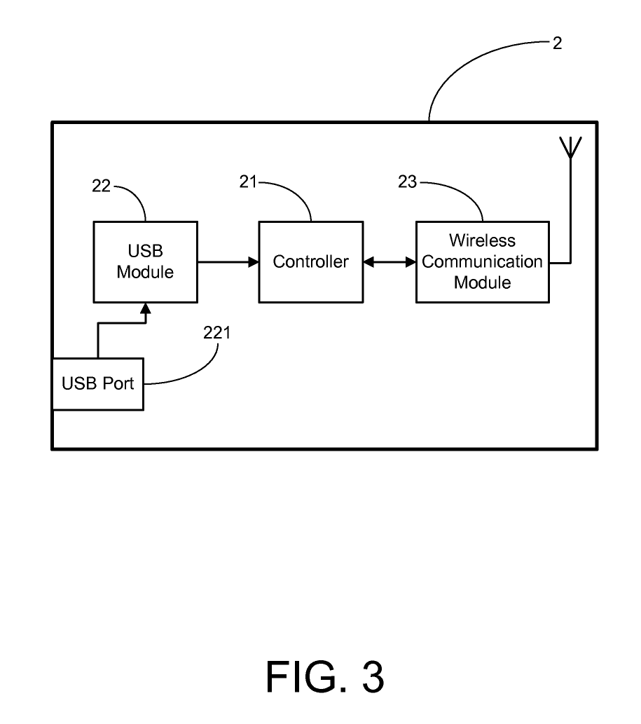

Please refer to FIG. 3, which shows a block diagram of the intermediary device 2. As shown, the intermediary device 2 includes a controller 21, a wireless communication module 23, a USB module 22 and at least one USB port 221. The USB module 22 and wireless communication module 23 are separately connected to the controller 21 and the USB port 221 is connected to the USB module 22. The USB port 221 is used for connecting the USB input device 3. The USB module 22 receives a data packet from the USB input device 3 connected to the USB port 221 and sends it to the controller 21, and then the controller 21 repackages the data packet and sends it the wireless communication module 23. The wireless communication module 23 may be a Bluetooth module or Wi-Fi module and wirelessly connects the handheld computer 1.

An embodiment has been described. Nevertheless, it will be understood that various modifications may be made without departing from the spirit and scope of the embodiments. Although an application of the method has been described, it should be recognized that numerous other applications are contemplated. Accordingly, other embodiments are within the scope of the following claims.

What is claimed is:

1. A method for operating a handheld computer by a Universal Serial Bus (USB) input device, comprising the following steps of:
a) connecting the handheld computer with an intermediary device through a wireless communication protocol and connecting the USB input device with the intermediary device through a USB cable;
b) intercepting a data packet from the USB input device;
c) repackaging the data packet; and
d) transmitting the data packet repackaged in step c) to the handheld computer.

2. The method of claim 1, wherein the wireless communication protocol is Bluetooth.

3. The method of claim 1, wherein the intermediary device comprises:
a controller;
a wireless communication module connected to the controller;
a USB module connected to the controller; and
at least one USB port connected to the USB module.
